(19) United States
(12) Patent Application Publication
(10) Pub. No.: US 2019/0257736 A1
(43) Pub. Date: Aug. 22, 2019

(54) System and Method for Precision Deposition of Liquid Droplets

(71) Applicant: Synelixis AB, Solna (SE)

(72) Inventor: Sarantis GIATRELLIS, Solina (SE)

(21) Appl. No.: 16/312,713

(22) PCT Filed: Jun. 21, 2017
(86) PCT No.: PCT/SE2017/050680

§ 371 Date: Dec. 21, 2018

(30) Foreign Application Priority Data
Jun. 21, 2016 (SE) 1650878-0

(51) Int. Cl. G01N 15/14

(52) U.S. Cl. CPC G01N 15/1404; G01N 2015/1006; G01N 15/1459

(57) ABSTRACT

The present invention relates to a system comprising a device having a nozzle for dispensing liquid droplets on a collection surface mounted on a horizontally moveable tray, characterized in that the system comprises indicating means capable of indicating a target position on the collection surface where the liquid droplets are dispensed by said nozzle, said system further comprising a camera arranged to capture image data of said collection surface at said target position. The invention also relates to a method for dispensing at least one liquid droplet onto a desired position on a surface of a collection device and to the use of a device having a flat surface coated with a coating that alters its optical properties when in contact with aqueous medium in calibration of a system according to the invention.

### FIELD OF THE INVENTION

The present invention relates to the field of laboratory or production instruments and in particular systems and methods for sorting particles or biological cells and the positioning of such particles or cells with high precision.

### BACKGROUND

Flow cytometers known in the art are used for analyzing and sorting particles in a fluid sample, such as cells of a blood sample or particles of interest in any other type of biological or chemical sample.

In a typical structure a flow cytometer consists of a fluidic system that creates and preserves a constant flow of a sheath fluid wherein a secondary flow, the sample flow, is injected concentricaly into the first. At a later position of these two flows are intersected by a laser beam. That position is called interrogation point. The light that is scattered at that position is collected and analysed by photo-multiplier tube (PMT). Following that there is an electric/electronic system for the physical separation—sorting—of selected particles. The aforementioned laser source belong to the discrete optical system of the flow cytometer while the PMTs, the signal processing unit and particle sorting subsystem belong to the electronic system of the flow cytometer.

A flow cytometer typically includes a sample reservoir for receiving a fluid sample, such as a blood sample, and a sheath reservoir containing a sheath fluid. The flow cytometer transports the particles (hereinafter called “particles”) in the fluid sample as a sample stream to a flow cell, while also directing the sheath fluid into the flow cell as a constant flow.

Within the flow cell, a constant and stable liquid sheath flow is formed by the sheath fluid driven by the constant sheath pressure. The sample stream is injected in the core of the sheath flow driven by a higher differential pressure and ensures laminar flow between the sheath flow. The hydrodynamically focused sample flow is directed to a position where laser beams are illuminating the particles within the stream. The point at which the sample flow intersects the laser beam is commonly known as the interrogation point. As a particle moves through the interrogation point, it causes the laser light to scatter. The laser light also excites components in the sample stream that have fluorescent properties, such as fluorescent markers that have been added to the fluid sample and adhered to certain particles of interest, or fluorescent beads mixed into the stream. The flow cytometer includes an appropriate optical detection system consisting of passive optical elements, photomultiplier tubes, photodiodes or other light detecting elements, which are collecting scattered light from the interrogation point at various angles. The flow cytometer analyzes the detected light to measure physical and fluorescent properties of the particles. The flow cytometer can further sort the particles based on these measured properties. The flow stream exits the flow cell via a nozzle with a nozzle diameter that is appropriate for the fluidics system and the particles size.

To sort particles by an electrostatic method, the desired particle must be contained within an electrically charged droplet that will be later deflected from its initial direction. To produce droplets, the flow cell is rapidly vibrated by an acoustic device, such as a piezoelectric element. The volume of a droplet is conventionally estimated by the hydrodynamic properties of the flow stream and the nozzle dimensions. To charge the droplet, the flow cell has an integrated charging element that applies an instant electric pulse that can charge a single or several droplets. Because the sample stream exits the flow cell in a substantially downward vertical direction, the droplets also propagate in that direction after they are formed. Droplets, whether they are charged or uncharged must be collected in a sample collection vessel that is appropriately directed to collect the one or more flow streams generated by the deflection plates. Accordingly, the droplets and the particles contained therein may be collected in appropriate collection vessels downstream of the plates. The velocity of the droplets is high enough to ensure a straight trajectory from the nozzle exit to the collection device thus neglecting the gravitational component.

Performing particle or cell sorting involves the setting of all aforementionedparameters and more. This makes every sorting set-up unique because all these parameters in ever may vary. Cell sorting to bulk number of cells is not affected by the small variation of the settings and can be reproducible without changing the settings. On the contrary when it comes to single cell sorting and especially when the liquid droplets need to be placed with a high spatial precision in the sub-millimeter range it is needed to perform a fine tunning before every experiment.

Commercially available flow cytometers refered to in the present are BD Influx, BD FACS Jazz, BD Aria, Beckman Coulter MoFlo XPD, Beckman Coulter MoFlo Astrios.

### SUMMARY OF THE INVENTION

The present inventor has identified a need in the art for a system that can position single liquid droplets on a solid support with very high spatial precision. The present invention aims to provide such systems. The present invention further aims to provide methods using such systems.

In a first aspect, the invention relates to a system comprising a device having a nozzle for dispensing liquid droplets on a collection surface mounted on a horizontally moveable tray, characterized in that the system comprises means for indicating a target position on the collection surface where the liquid droplets are dispensed by said nozzle, said system further comprising a camera arranged to capture image data of said collection surface at said target position.

In one embodiment, the system according to the invention comprises a light source emitting a focused beam of light, and wherein the light source is capable of being arranged to direct the beam of light to a target position on the collection surface where the liquid droplets are dispensed by said nozzle, said system further comprising a camera arranged to capture image data of said collection surface at said target position.

In a another embodiment, the means for indicating the target position comprises a pattern image indicating the target position, said pattern image being superimposed on the display image data captured by the camera.

In another aspect, the invention relates to a method for dispensing at least one liquid droplet onto a desired position on a surface of a collection device, comprising the steps of mounting said collection surface onto the moveable tray within a system according to the invention, wherein the indicating means are arranged to indicate the target position on the collection surface, and moving the tray so that the desired position on the collection surface coincides with the indicated target position illuminated by the light source.

In a further aspect, the invention relates to use of a device having a flat surface coated with a coating that changes optical properties when in contact with aqueous medium in calibration of a system according to the invention.

Embodiments of the above aspects are set out in the dependent claims.

### BRIEF DESCRIPTION OF THE DRAWINGS

FIG. 1 is a side view illustration of one embodiment of the system according to the invention.

FIG. 2 is a top view illustration of one embodiment of the system according to the invention.

FIG. 3 is a side view illustration of a further embodiment of the system according to the invention.

FIG. 4 is (A) a schematic illustration of the prototype and (B) a schematic representation of a calibration slide used for aligning the light beam with the droplet trajectory on the collection device plane.

FIG. 5 is a schematic illustration of a system using a pattern image as indicating means.

FIG. 6 is a schematic illustration of a computer display of a computer comprised in the system according to the invention.

### DETAILED DESCRIPTION OF THE INVENTION

The currently commercially available flow cytometers can sort cells and other particles into relatively large collection vessels and well plates based on a number of selection criteria. The collection vessels or wells thus, after a run, each contain a population of cells having the characteristics on which the sorting was decided.

In a number of applications, it would be advantageous to be able to select single cells by flow cytometry and sort these individual cells on a defined position on the surface of a collection device, which may be a flat surface or a welled plate, with very high precision. The present invention thus aims to provide a system that can sort cells based on selection criteria and place cells showing desired characteristics at a specified location with high precision.

In order to deflect a stream of liquid droplets into a uniform stream, the liquid droplets should be uniform in terms of weight and charge. This is generally achievable with commercially available flow cytometers. It is also possible to achieve an ordered array of droplets on a collection surface by stepwise movement of the collection surface between each droplet, and synchronizing the movement of the collection surface with the time interval between droplets.

However, when it is important to sort the liquid droplets onto specific positions on the collection surface, such as positions with unique modifications, the problem of aligning the position of the collection surface and the droplet stream arises. In theory, this could be addressed by manufacturing collection devices and trays holding the collection devices with extremely high precision. This is however very difficult if the liquid droplets are to be placed with a precision in the sub-millimeter range added to the fact that flow cytometers capable of single cell sorting are uniquely set up for every experiment. Set-up involves optical alignment, hydrodynamic alignment, electrical charging fine tuning, collecting device positional alignment. In the cases of collecting devices that are in the sub-millimeter scale, a few extra steps of aligning are required when sorting sequentially on more than one devices.

The present invention aims to solve this problem by providing a system wherein indicating means is used to highlight the position on the collection surface where a liquid droplet is placed when the system is in use. Following that, this information is used when one wants to sort a single cell(s) on a specific position(s) on the collection surface; the desired position(s) on the collection surface will be aligned according to the highlighted position.

Consequently, the system according to the invention comprises an apparatus having a nozzle for dispensing liquid droplets on a surface mounted on a horizontally moveable tray. In a preferred embodiment, the apparatus is a cell sorting apparatus, such as a Fluorescence Activated Cell Sorting (FACS) apparatus, but also other types of apparatus, such as microarrayers, can benefit from the present invention.

In a FACS apparatus, the individual liquid droplets formed by nozzle vibrations are substantially identical in terms of weight and volume. The droplets are charged with a variable electrical charge. The trajectory of the droplets can be then adjusted by applying an electrical field which deflects the droplets according to their polarity and charge magnitude. All droplets having the same charge will have the same trajectory in the electrical field. The droplets can therefore be directed according to at least three different trajectories, based on a positive charge, a negative charge or no charge.

In the present system, a collection surface intersecting one droplet trajectory is arranged below the nozzle so that droplets can be placed on the collection surface. The collection surface is in turn mounted in a tray that can be moved in a horizontal plane. The tray is a part of the FACS apparatus.

As discussed above, in some applications it is desirable to have droplets located in specific desired positions on a solid surface. In the context of this specification, such positions are termed “desired positions” or “DP”. The position on the solid surface where the surface intersects the droplet trajectory is analogously termed the “target position”, or “TP”. The device onto which the droplets are placed is called a “collection device” and the surface of the collection device is called “collection surface”.

In order to place the droplet at a desired position on the collection surface, it is necessary to align the target position and the desired position of the collection surface, i.e. to adjust the position of the collection device so that the position on the collection surface where the collection surface intersects the droplet trajectory corresponds to the position where it is desired to have the droplet placed.

In a first embodiment, the present invention achieves this alignment by using a focused light beam to illuminate the exact target position. An image of the thus illuminated collection surface is captured by a camera and the image data is used to adjust the position of the collection surface so that the desired position is moved to correspond to the target position. When the collection surface is in the correct position, a liquid droplet exiting the apparatus nozzle can be deflected to the corresponding trajectory and placed at the desired position on the collection surface.

The light source that is used to illuminate the target position can be any light source that can produce a beam of light that can be focused or otherwise adjusted to illuminate an area that is in the same order to the area of the planar surface occupied by one droplet. Typical range for the droplet-occupied-area diameter is 800-400 μm. Typical value for light spot diameter is 250 μm. The light source is preferably a laser, such as a red laser with low effect (typical values: 10 mW to 1 mW). The light source can complementary comprise of passive optical elements as lenses and pinholes.

The light source is preferably provided on an adjustable mounting, which may be manually operated or servo-mechanism operated, so that the direction of the light beam can be adjusted. The light source can also be provided in a fixed arrangement and the light beam further adjusted by an optical element.

The system also comprises a camera that can capture image data of the surface. The image data shows the relative positions of the desired positions, identified for example by the spatial arrangements of surface modifications or other type of marking, and the target position. The tray holding the collection device may then be moved to position the collection surface so that the desired position is at the target position. The movement of the tray is preferably motorised and may be controlled by a user or automated.

In one embodiment, the camera may be mounted so that it moves with the moveable tray, i.e. in a fixed position relative the collection surface. In a further embodiment the camera may also be mounted in a fixed position in the system, while the collection surface is mounted on a moveable tray that is consequently moveable in relation to the camera.

In a further embodiment, the means for indicating the target positioncomprises a pattern image indicating the target position, said pattern image being superimposed on the display image data captured by the camera arranged to capture image data of the collection surface. The image data captured by the camera is transferred to a computer adapted to display the image of the collection surface on a monitor and furthermore superimposing a pattern image on the collection surface image, wherein the pattern image serves to indicate the target position on the collection surface. The pattern could be any type of pattern that is usefule for indicating a position, such as crossing lines or cross-hairs, concentric circles, etc.

In this embodiment, the camera is preferably arranged in a fixed position in the system, while the collection surface is mounted on a moveable tray that is consequently moveable in relation to the camera.

In one embodiment, the means for indicating the target positioncomprises both the light source indicating the target position by means of a focused light beam, and the pattern image superimposed on the image data captured by the camera in the system.

In one embodiment, the image data of the collection surface is displayed to a user. The target position is indicated by the indicating means and the user identifies a desired position for placement of the liquid droplet. The user then directs the movement of the tray by providing instructions to a computer programmed to produce an output signal effective to operate motorised horizontal movement of the moveable tray in response to input provided by the user. The image data displayed to the user enables the user to continuously monitor the collection surface and to align the selected desired position with the target position.

In one embodiment, the image data of the collection surface is displayed to a user and the user is prompted to indicate a position on the collection surface as a desired position. The coordinates of the indicated position are transferred to a computer programmed to operate movement of the tray to align the indicated desired position with the target position.

In one embodiment, the collection surface onto which the liquid droplets are to be placed is provided with a mark indicating a desired position. Image data of the surface is transferred to a computer programmed to identify the mark and the target position indicated by the light beam, and to operate movement of the tray to align the indicated desired position with the target position.

In further embodiments, the tray in which the collection device is mounted is moved stepwise in the horizontal plane to position a further desired position in the target position and a further liquid droplet is placed in the further desired position. This could be repated a plurality of times to spatially arrange a plurality of liquid droplets in an array. The number of discrete positions in the so produced array is essentially only limited by the size of the solid surface, the size of the droplets, and the desired space between desired positions.

In theory, a new alignment can be made before placing a liquid droplet in each new desired position but in practice a new alignment will be made with certain intervals that will depend on the spacing of desired positions on the collection surface and the precision of the machinery that effects movement of the tray holding the solid surface.

The collection surface onto which the liquid droplets are placed may be a flat surface, such as a glass, plastic or silicon slide. The collection device may also be a plate comprising a plurality of wells. Dimensions of the wells span from milimeter scale to micrometer. Such plates are well-known in the biotechnological arts and are commonly referred to as microtiter plates, microplates or microwell plates. This is further discussed below in connection with the description of the method aspects of the invention, which description also applies to the system aspect of the invention.

Preferably, the system also comprises a waste collection container arranged to collect droplets having a charge and trajectory different from the droplets that are deflected to be placed on the collection surface.

Before cell sorting, the system must be calibrated so that the light beam is directed exactly to the target position. One example of a calibration methodology is set out below.

The system is configured to provide the desired size and charge of liquid droplets. A calibration device having a surface coating that changes its optical properties when in contact with aqueous medium is provided and placed on the tray of the system as a collection device. A single test droplet is sorted on a random position on the calibration surface, which causes the appearance of the calibration surface to change at the target position. The change in the optical properties of the calibration slide will outline the landing position of the droplet. For higher precision in calibrating, fluorescently labeled beads can be used. Then the indicating means is adjusted so that it indicates a position on the calibration surface exactly at the target position (i.e. the intersection of the sorting trajectory with the XY plane of the collecting surface) on the trace of the collected test droplet. This calibration procedure may be repeated with several droplets on the same calibration surface.

Thus, in a further aspect, the invention relates to the use of a device having a flat surface coated with a coating that changes optical properties when in contact with aqueous medium in calibration of a system according to the invention. This calibration device is preferably a slide or plate made of glass or plastic or any other suitable material. If the camera is mounted beneath the moveable tray and the light source is mounted above the moveable tray, or vice versa, it is preferable that the calibration device is made of a transparent material. The setup can also be realised with the light source and camera on the same side.

The surface coating on the calibration device may be Bovine Serum Albumin saline solution 1%.

In a further aspect, the present invention relates to a method for dispensing at least one liquid droplet onto a desired position on a surface of a collection device, comprising mounting said collection device onto the moveable tray within a system according to the above mentioned aspect of the invention, wherein the indicating means is arranged to indicate the target position and moving the tray so that the desired position on the collection surface coincides with the indicated target position.

In one embodiment, the method further comprises placing a plurality of liquid droplets onto an equal plurality of discrete desired positions on the collection surface. This can be achieved by stepwise movement of the tray holding the collection device, which movement is synchronized with the time interval between droplets in the droplets stream emerging from the device nozzle.

In a further embodiment, the liquid droplets comprise single cells, such as living cells. The cells may be of any origin. In particular when the system is configured to comprise a flow cytometer, the cells may be of any type or species that is amenable to analysis by flow cytometry.

In a further embodiment, the method comprises dispensing at least 100, such as at least 500, at least 1000, at least 2000, or at least 3000, liquid droplets onto an equal plurality of discrete desired positions on a single collection surface.

In a further embodiment of the invention, the discrete desired positions are spaced 1 mm apart or less, such as 0.4 mm or 0.2 mm apart or less, on the collection surface.

The collection surface onto which the liquid droplets are placed may be a flat surface, such as a glass, plastic or silicon slide. Such slides may be treated in various ways to facilitate further study of cells included in the liquid droplets placed on the slides. In particular, the slides may have an array of surface modifications at a plurality of positions where it is intended to place liquid droplets. Such surface modifications may be identical in all positions, unique to each position, or identical within a group of positions but unique in relation to other groups of positions.

The surface modification in the various positions may also include a modification that is visible to the system or the user, in order to facilitate the alignment of the desired position and the target position using the system of the invention.

The collection device may also be a plate comprising a plurality of wells. Such plates are well-known in the biotechnological arts and are commonly referred to as microtiter plates, microplates or microwell plates. Microwell plates typically have 6, 24, 96, 384, 1536, 3456 or 9600 sample wells in a 2:3 rectangular matrix, wherein each well functions as a test tube. Microwell plates are commonly manufactured in polystyrene, polypropylene or polycarbonate, but may also be manufactured in other materials such as other plastics, glass, or quartz.

If the system according to the invention is used for sorting single live cells which should be further cultivated, it is of course recommendable that the surface is modified as known in the art to allow for cell culture. This includes i.a. modification by oxygen plasma discharge to make the surfaces more hydrophilic.

If the camera is mounted beneath the moveable tray, it is preferable that the collection device is made of a transparent material.

The invention is now described in relation to the figures.

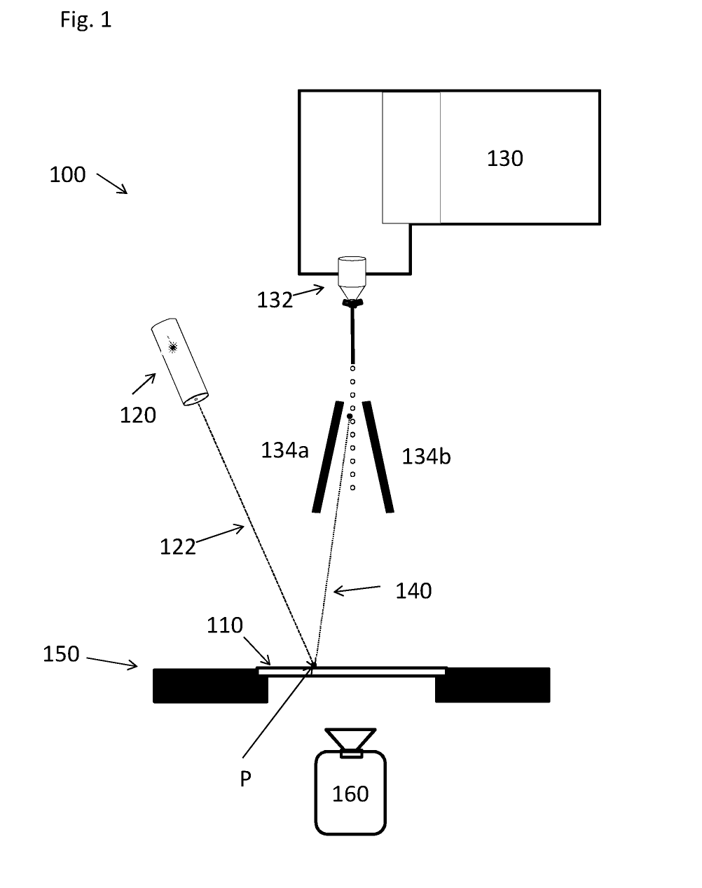

FIG. 1 is a schematic side view of a system (100) comprising a device (130) having a nozzle (132) for dispensing liquid droplets (140). The nozzle also comprises a charging element to electrically charge the droplets (140) and electrically chargeable deflectors (134a, 134b) that deflect the stream of droplets (140) to a specified trajectory. The system further comprises a tray (150) that is moveable in the horizontal X-Y plane. When in use, a collection device having a collection surface (110) is positioned on the moveable tray (150). The point where the stream of droplets (140) would hit the collection surface (110) is marked with P.

The system further comprises a light source (120) emitting a focused beam of light (122) directed to the collection surface. When the system (100) is calibrated as described above, the beam of light (122) also hits the collection surface (110) at point P, thus marking the exact position on the collection surface (110) where the stream of liquid droplets will hit the collection surface (110).

A camera (160) is arranged beneath the tray (150) to capture image data of the collection surface (110). In a configuration such as described in FIG. 1, the moveable tray (150) comprises an opening allowing image data of the collection device to be captured from beneath. The collection device is preferably placed on chamfers at the edge of this opening. Furthermore, the collection device is made of a transparent material such as glass, quartz, or plastic in order for image data of the collection surface (110) to be captured by the camera (160).

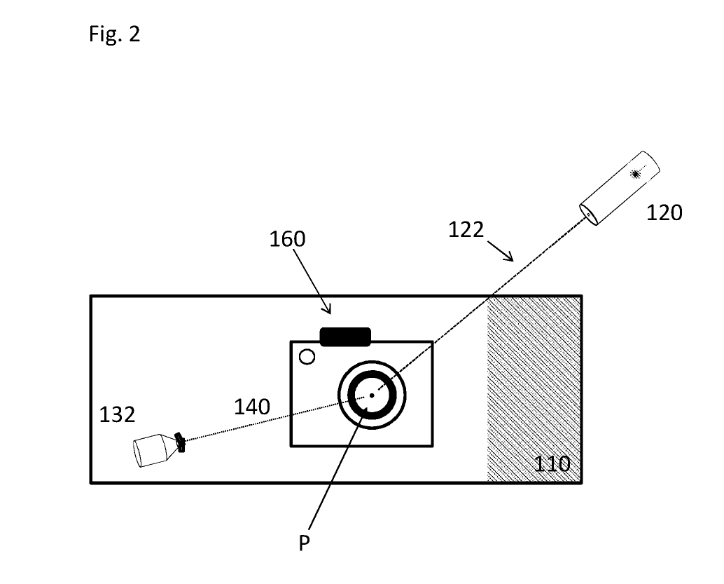

FIG. 2 shows a top view of selected parts of the system as shown in FIG. 1. The camera (160) is placed beneath the collection surface (110) and arranged to capture image data of the collection surface (110) at the position P where the collection surface (110) intercepts the trajectory of the liquid droplets (140) and the light beam (122).

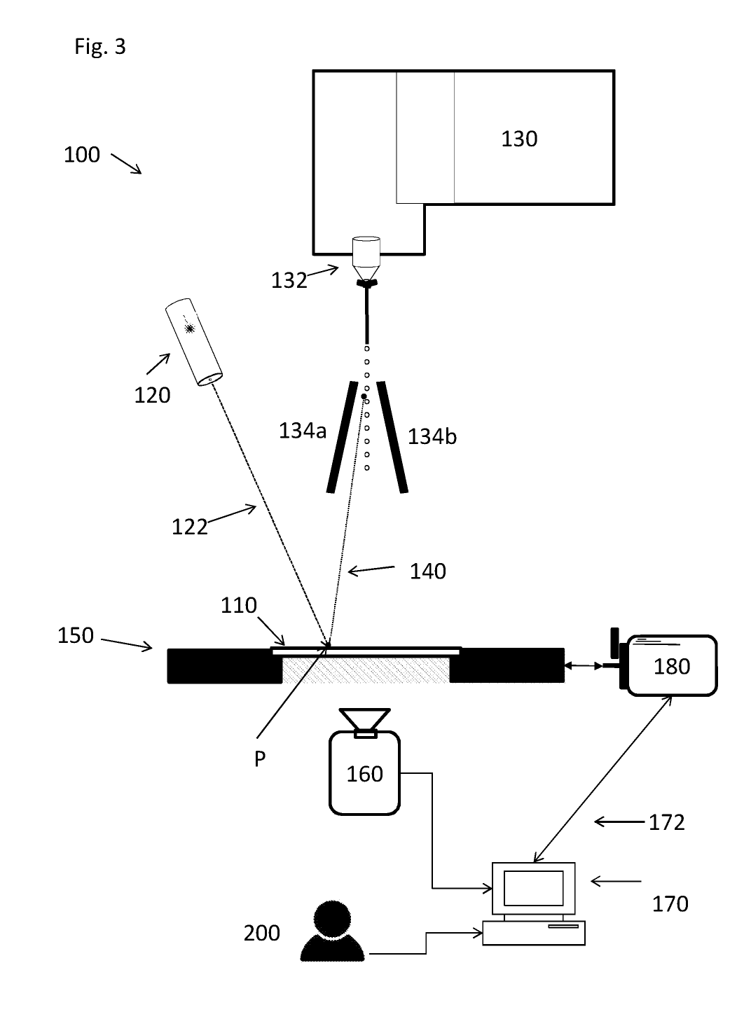

FIG. 3 is a schematic illustration of a system as illustrated in FIG. 1, further comprising a computer (170) programmed to produce an output signal (172) effective to operate motorised horizontal movement of the moveable tray (150), by a motor (180), in response to image data captured by said camera (160). The computer may also be programmed to produce an output signal (172) effective to operate motorised horizontal movement of the moveable tray (150), by a motor (180), in response to input provided by a user (200).

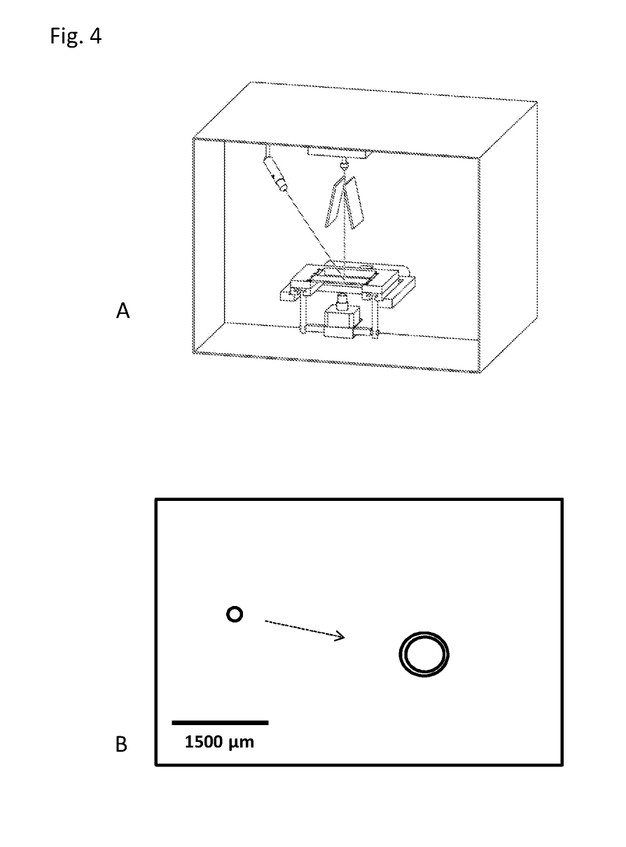

FIG. 4 is (A) a 3-D schematic illustration of a prototype and (B) the schematic representation of the calibration slide used where the concentric cirlces represent the trace of a single droplet that was sorted at a random position on the calibration slide and the solid circle represents the laser beam trace that is to be aligned with the sorted droplet trace.

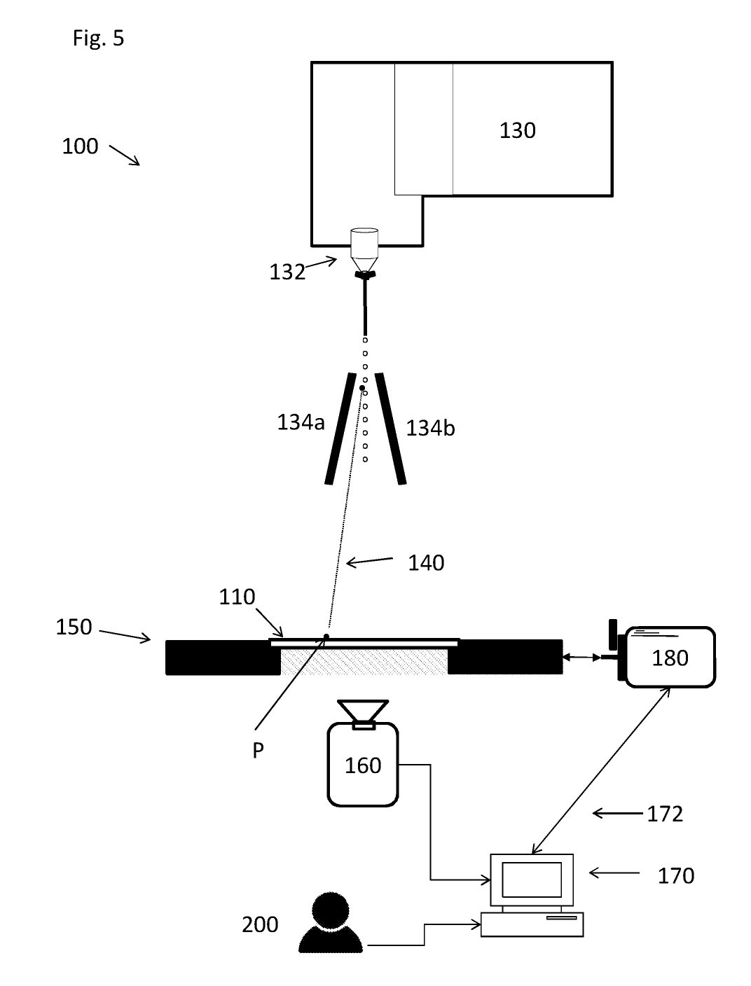

FIG. 5 is a schematic illustration of a system using a pattern image as indicating means. This system comprises a computer (170) having a display that can reproduce the image data captured by the camera (160). Furthermore, the computer (170) is configured to produce a pattern image indicating the target position (TP) on the collection device and superimposing said pattern image on image data captured by the camera (160), and displaying the combined image on the display of the computer (170). The computer (170) may further, in analogy with the system shown in FIG. 3, be programmed to produce an output signal (172) effective to operate motorised horizontal movement of the moveable tray (150), by a motor (180), in response to image data captured by said camera (160). The computer may also be programmed to produce an output signal (172) effective to operate motorised horizontal movement of the moveable tray (150), by a motor (180), in response to input provided by a user (200).

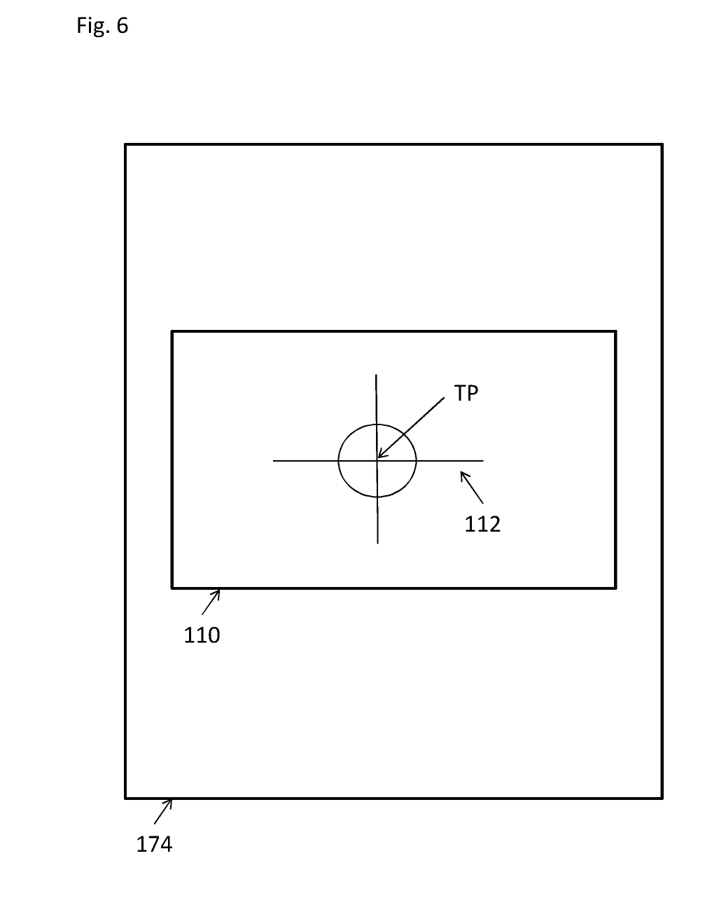

FIG. 6 is a schematic illustration of the computer display (174) of the computer (170). The image produced on the display comprises image data of the collection surface (110) and, superimposed thereon, a pattern image (112) indicating the target position (TP) where it is intended to dispense the liquid droplets (140) (droplets not shown in this figure).

### EXAMPLES

A prototype was built and tested extensively on a BD Influx flow cytometer.

The prototype built was composed of the following; the light source was a red laser module 650 nm of 5 mW effect. The laser module was focusable, baring a glass lenses and a pinhole for achieving the desired dot size. The laser dot trace size was 0.25±0.2 mm. The laser module was mounted on a ball-joint mount that allows for free rotation of 75 degrees solid angle. The laser was mounted on the roof of the sorting chamber on a position apropriate to aim on the target position.

The camera used was a usb 5MP camera with a 75 degree lens. The camera was adopted to the sorting-tray slide holder of the BD Influx using a customized aluminium mount and it was connected to the computer unit that runs the FACS interface software.

The system was calibrated using a callibration slide as shown in FIG. 4. The laser trace is initialy at a random position. Sorting a single particle (cell or polystyrene bead) at another random position will create the droplet trace on the calibration slide. The next step of the calibration is to manually align the laser trace to coincide with the sorting trace of that single particle that was sorted. The calibration process took less than 15 seconds.

After this, the system is calibrated to sort on demand to any position on the slide by only adjusting the coordinates of the sorting tray through the FACS software aided by the camera live image of the collecting slide. The positioning precision was at least 0.1 mm.

1. A system comprising a particle sorting device having a nozzle for dispensing liquid droplets on a collection surface mounted on a horizontally moveable tray, wherein the system comprises means for indicating a target position (TP) on the collection surface where the liquid droplets are dispensed by said nozzle, said system further comprising a camera arranged to capture image data of said collection surface at said target position (TP).

2. The system according to claim 1, wherein the means for indicating a target position comprises a light source configured to emit a focused beam of light, and wherein the light source is capable of being arranged to direct the beam of light to the target position.

3. The system according to claim 2, wherein the light source is a laser, and wherein the diameter of the light beam is less than or equal to 250 μm at the surface.

4. The system according to claim 1, wherein the camera is arranged in a fixed position in relation to the collection surface.

5. The system according to claim 1, further comprising a computer programmed to receive and display image data captured by the camera.

6. The system according to claim 1, wherein the means for indicating a target position (TP) comprises a pattern image indicating the target position, said pattern image being superimposed on the display image data captured by the camera.

7. The system according to claim 6, wherein the collection surface is moveable in relation to the camera.

8. The system according to claim 1, further comprising a computer programmed to produce an output signal effective to operate motorized horizontal movement of the moveable tray in response to input provided by a user.

9. The system according to claim 1, further comprising a computer programmed to produce an output signal effective to operate motorized horizontal movement of the moveable tray in response to image data captured by said camera.

10. The system according to claim 9, wherein the computer is programmed to receive coordinates of a position indicated as a desired position by a user and to operate movement of the tray to align the indicated desired position with the target position based on the captured image data.

11. A method for dispensing at least one liquid droplet onto a desired position on a surface of a collection device, comprising the steps of mounting said collection surface onto the moveable tray within a system according to claim 1, wherein the means for indicating are arranged to indicate the target position on the collection surface, and moving the tray so that the desired position on the collection surface coincides with the target position indicated by the means for indicating.

12. The method according to claim 11, further comprising the step of placing a plurality of liquid droplets onto an equal plurality of discrete desired positions on the collection surface.

13. The method according to claim 12, comprising the step of producing the liquid droplets to comprise single cells.

14. The method according to claim 13, wherein the cells are living cells.

15. The method according to claim 11, comprising the step of dispensing at least 100 liquid droplets onto an equal plurality of discrete desired positions on a single collection surface.

16. The method according to claim 15, wherein the discrete desired positions are spaced 1 mm apart or less on the collection surface.

17. The method according to claim 15, wherein the collection surface onto which the liquid droplets are dispensed is substantially flat.

18. The method according to claim 15, wherein the collection surface onto which the liquid droplets are dispensed is welled.

19. A method of using a device having a flat surface coated with a coating that changes optical properties when in contact with aqueous medium in calibration of a system according to claim 1.
